(19) United States
(12) Patent Application Publication
(10) Pub. No.: US 2026/0104917 A1
(43) Pub. Date: Apr. 16, 2026

(54) DYNAMIC PLUGGABLE DATA PROCESSING PIPELINE

(71) Applicant: American Express Travel Related Services Company, Inc., New York, NY (US)

(72) Inventors: Hemant Narayan Dhakate, Phoenix, AZ (US); Swagata Ghosh, Phoenix, AZ (US); Rahul Agarwal, Noida (IN); Satyendra Hiredesai, Phoenix, AZ (US)

(21) Appl. No.: 18/915,796

(22) Filed: Oct. 15, 2024

(51) Int. Cl. G06F 9/48; G06F 9/451

(52) U.S. Cl. CPC G06F 9/4881; G06F 9/451

(57) ABSTRACT

An example operation may include at least one of receiving a job start request which includes a job template identifier and one or more job creation tags, creating a sequence of job steps based on a job template identified by the job template identifier, removing one or more job steps in the sequence of job steps that do not correspond to the one or more job creation tags, wherein one or more job steps that remain comprise a pipeline job, populating a job step of the one or more job steps that remain in the pipeline job with a set of rules associated with the job step from the one or more rules or replacing one or more placeholders in the set of rules of the job step in the pipeline job with one or more placeholder values.

### BACKGROUND

In computing, a pipeline, or data processing pipeline, refers to a set of data processing elements, where the output of one element is the input to the next element. A pipeline generally includes a source node of input data, a processing node that processes the input data, and a sink node which is a destination of the processed data.

### SUMMARY

One example embodiment provides a system that includes a data store configured to store one or more job templates and one or more rules and a processor communicatively coupled to the data store, wherein the processor is configured to perform at least one of receive a job start request which includes a job template identifier and one or more job creation tags, create a sequence of job steps based on a job template identified by the job template identifier, remove one or more job steps in the sequence of job steps that do not correspond to the one or more job creation tags, wherein one or more job steps that remain comprise a pipeline job, populate a job step in the pipeline job with a set of rules associated with the job step from the one or more rules, replace one or more placeholders in the set of rules of the job step in the pipeline job with one or more placeholder values, link the one or more job steps in the pipeline job into a job step Directed Acyclic Graph (DAG), associate the job step DAG with the pipeline job, submit the pipeline job to a pipeline for execution, and execute the pipeline job in the pipeline in accordance with the job step DAG.

Another example embodiment provides a method that includes at least one of receiving a job start request which includes a job template identifier and one or more job creation tags, creating a sequence of job steps based on a job template identified by the job template identifier, removing one or more job steps in the sequence of job steps that do not correspond to the one or more job creation tags, wherein one or more job steps that remain comprise a pipeline job, populating each job step in the pipeline job with a set of rules associated with the job step from the one or more rules, replacing one or more placeholders in the set of rules of a job step in the pipeline job with one or more placeholder values, linking the one or more job steps in the pipeline job into a job step Directed Acyclic Graph (DAG), associating the job step DAG with the pipeline job, submitting the pipeline job to a pipeline for execution, and executing the pipeline job in the pipeline in accordance with the job step DAG.

A further example embodiment provides a computer readable storage medium comprising instructions, that when read by a processor, cause the processor to perform at least one of receiving a job start request which includes a job template identifier and one or more job creation tags, creating a sequence of job steps based on a job template identified by the job template identifier, removing one or more job steps in the sequence of job steps that do not correspond to the one or more job creation tags, wherein one or more job steps that remain comprise a pipeline job, populating a job step in the pipeline job with a set of rules associated with the job step from the one or more rules, replacing one or more placeholders in the populated set of rules of the job step in the pipeline job with one or more placeholder values, linking the one or more job steps in the pipeline job into a job step Directed Acyclic Graph (DAG), associating the job step DAG with the pipeline job, submitting the pipeline job to a pipeline for execution, and executing the pipeline job in the pipeline in accordance with the job step DAG.

### BRIEF DESCRIPTION OF DRAWINGS

FIG. 1 is a system diagram illustrating an operating environment of a data processing pipeline, according to examples and features of the instant solution.

FIG. 2 is a diagram illustrating a process for pipeline job construction that supports tag-based execution paths, according to the examples and features of the instant solution.

FIG. 3 is a diagram illustrating a process for placeholder resolution and replacement according to examples and features of the instant solution.

FIG. 4 is a diagram illustrating a process for inline data quality verification according to examples and features of the instant solution.

FIGS. 5A-5B are flow diagrams illustrating pipeline job creation and execution according to examples and features of the instant solution.

FIG. 6 is a system diagram illustrating a computing environment according to example features, structures, or characteristic of the instant solution.

### DETAILED DESCRIPTION

It is to be understood that the features and examples of the instant solution described or depicted in this disclosure can be configured and performed in a variety of operating environments, including cloud computing, with various wired and wireless connections, direct or indirect connections, utilizing various protocols and computing devices. These features and examples are capable of being implemented in conjunction with any type of computing or networking environment now known or later developed.

The instant solution provides a more flexible data processing pipeline (instead of a typical pipeline which includes hard-coded job steps) by enabling a single job configuration template to support multiple execution paths. This functionality is useful for sets of jobs with similar, but not completely identical functionality. Further flexibility may be provided by the introduction of recursively replaceable placeholders in the job configuration which enable different data sources, data sinks and transformation rules to be applied within various job steps. Further, execution flexibility may be enhanced with the inclusion of inline data quality checks which enable halting a pipeline job during execution (instead of a traditional approach of performing data quality checks pre-pipeline or post-pipeline job execution).

The instant solution describes a pipeline management framework for a data processing pipeline that enables dynamic and pluggable job creation and execution using configuration data. In some examples, JavaScript Object Notation (JSON) can be used as the configuration format. A job template may be configured to define a series of steps for extracting data from one or more sources, transforming the extracted data from previous steps, and storing the transformed data in one or more data stores. The steps that may be performed by a job and the dependencies between those steps may be stored in configuration files.

The instant solution includes various features that enable dynamic pipeline job creation and execution. One feature consists of dynamic tagged job execution paths. In traditional systems, a job is configured separately even if other jobs have very similar, but not identical steps. The instant tagged execution path feature may enable a single job configuration (or template) to be used by various similar, but slightly different jobs, by passing in one or more tags which control the execution path. These tags control the creation of a Directed Acrylic Graph (DAG) of job steps in a job and therefore determine what the pipeline actually executes. Using one job template across many jobs results in fewer step component definitions as these components are defined once. Further, if an issue arises, a single update to the template may be configured to rectify the issue across all of the jobs.

Another feature of the instant solution consists of recursive and instant placeholder evaluations. In traditional systems, a job often includes steps with hard coded source, transformation and sink functions. The instant placeholder evaluation feature may be configured to enable developers and computing systems to have templatized code for steps with markers that define data sources, transformations and data sinks with placeholders that are replaced with actual values before execution. These placeholders may contain other placeholders which may be configured to recursively update with actual values that are used during job execution in the pipeline.

A further feature of the instant solution may be configured to perform inline, concurrent data quality checks. In traditional systems, data quality checks are performed after execution of a job running on the data. The instant inline data quality feature may be configured to enable detection of data quality issues during the execution of the job so that the job may be marked as failed (with details recorded) prior to execution being completed across the entire data set. As with placeholders, these data quality steps are inserted into the job step DAG (i.e., inserted between other steps) based on data quality insertion rules in the job configuration.

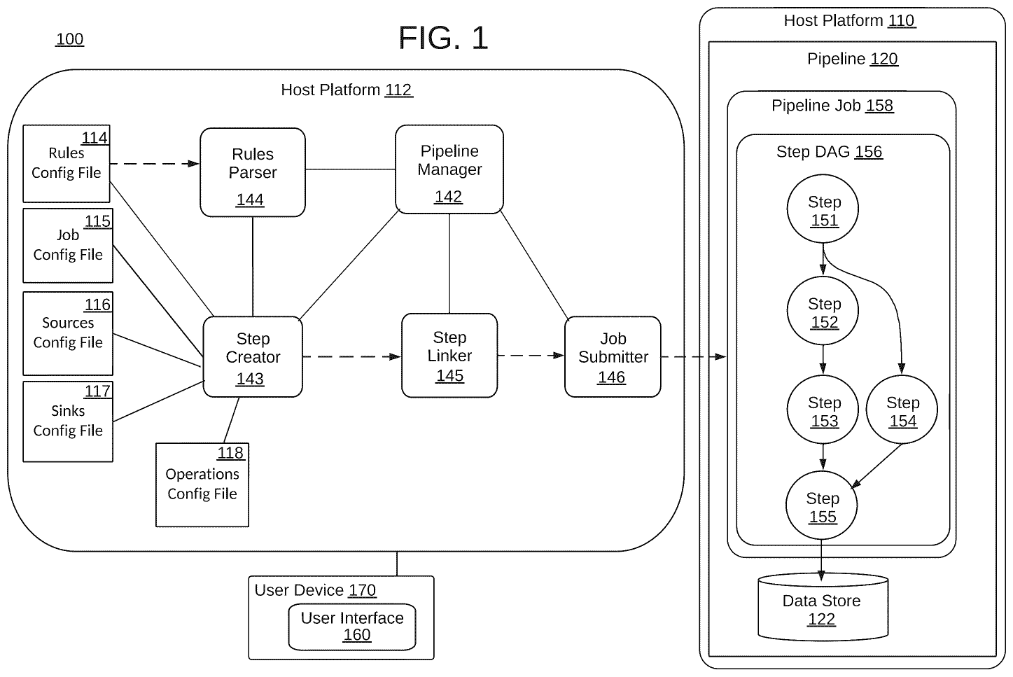

FIG. 1 is a system diagram illustrating an operating environment 100 of a data processing pipeline management and execution system, according to examples and features of the instant solution. Referring to FIG. 1, the data processing pipeline 120 resides on a host platform 110, which may be a server, container, virtual machine, or the like. The data processing pipeline 120 may include a data store 122 (which may be a database, a file system, and the like) that can be used to store data associated with job execution on the data processing pipeline 120.

In this example, pipeline job management components 142-146 are hosted by host platform 112, which may be a server, container, virtual machine, or the like. The pipeline job management components include a pipeline manager 142, which may be a software application or a suite of software applications, able to configure the processing pipeline 120 on the host platform 110. The pipeline manager 142 can configure jobs that may be run on the processing pipeline 120 based on configuration files 114-118. According to examples and features of the instant solution, the configuration files 114-118 may be encoded in JSON, eXtensible Markup Language (XML), and the like, and stored in a file system, a database, or packaged with an application code artifact (a collection of files that define an application's design, architecture, and functionality). Further, though depicted as being resident on host platform 112, one or more of the configuration files 114-118 may be stored remotely and accessed via an Application Programming Interface (API). In some examples, host platforms 110 and 112 may be a single platform and may be any of the computer systems or modules described or depicted herein.

According to various examples and features of the instant solution, when the pipeline manager 142 receives a start job request, it includes one or more of a job template identifier, a location of the job configuration data that includes the job templates, an optional list of job tags, and optional parallelism configuration data. In some examples, the start job request is initiated manually via a user interface 160 appearing on a display of a device 170 containing a processor and/or memory (such as a cell phone, watch, personal computer, laptop, any of the computer systems/servers or modules described or depicted herein, and the like). In other examples, the start request may be initiated by an automatic scheduling system (not shown) via a device containing a processor and/or memory. The job template identifier enables the pipeline manager 142 to locate a job template which defines the steps to be executed. In some examples, the job templates are stored in a job config file 115 on the local filesystem. The step definitions further link to corresponding configuration data related to the steps. For example, sources config file 116 may include instructions for configuring one or more data source(s) of the processing pipeline, the sinks config file 117 may include instructions for configuring one or more data sink(s) of the processing pipeline, and the operations config file 118 may include instructions for configuring one or more data transformation operations within the processing pipeline 120. Further, an operation entry in the operations config file 118 for a particular operation may include the transformation type, and a rules entry which includes a rules location, such as a path to the rules config file 114, along with one or more rule identifiers, which specify the rules that apply to the particular operation.

Referring again to FIG. 1, the host platform 112 includes modules such as a step creator 143, a rules parser 144, a step linker 145, and a job submitter 146. Each of the modules 143-146 may be managed or controlled by the pipeline manager 142. The pipeline manager 142 uses the step creator module 143 to parse the job config file 115 to identify a type of job to be performed based on a particular job template identifier. The step creator module 143 extracts the step definitions for the target job. These step definitions include an identifier, one or more dependencies on other step(s) in the job definition, and optionally one or more job tags which enable filtering of the job steps to be used when creating a new pipeline job. In one example of the instant solution, a dependency is expressed as a predecessor step identifier. In another example of the instant solution, a dependency is expressed as a successor step identifier. Once parsing has been executed, the initial set of steps is filtered into a list of steps for the new pipeline job based on the one or more of the job tags supplied in the start request. If no job tags were included in the start request, then all the initial steps identified in the job template are used.

In some examples and features of the instant solution, the step creator 143 creates various steps 151-155 for each step in the new pipeline job 158. Each step corresponds to a pipeline operation, whose input may include, but is not limited to, configuration in the configuration files 114-118 and output from any previous steps. Steps support a variety of operations including, but not limited to, source, sink, transform, look up, and data quality check. Source steps are responsible for reading the source of a type of data store such as, but not limited to, a file, a database or a stream. Sink steps are responsible for writing data into a data store, such as, but not limited to, a file, a database or a stream. Transform steps are responsible for transforming input data into another form and may include types such as, but not limited to, map, group, filter or join. As steps (or operations) vary in purpose, steps may include operation-specific configuration, source code, and rules. In some examples, these rules are stored in a rules config file 114. In some examples these rules are stored in a database or remotely and accessed via an API. The step creator 143 utilizes a rules parser 144 to parse and resolve the rules to include in each step 151-155. In some examples and features of the instant solution, the resolved rules are compiled and stored in a local cache by the rules parser 144 before being returned to the step creator 143. This ensures the most optimal execution speed when the job is actually run in the pipeline 120.

In some examples and features of the instant solution, step configuration, source code and rules may optionally contain string placeholders (e.g. $tableName) as markers to be replaced before job execution in the pipeline 120. String placeholders provide flexibility to job developers as they enable common template code which can then be updated with specific values for any job. In one example, a single job may be applicable to a variety of database tables, so the value for the $tableName placeholder might be passed in as a parameter, or sourced from a file, database or API call. Further, rules themselves may be defined as placeholders and nested (e.g. $rule1=$rule2+$rule3).

In this example, upon receiving the list of steps 151-155, the pipeline manager 142 sends the list of steps to a step linker 145 module which generates a job step Directed Acyclic Graph (DAG) 156, which is a representation of a series of operations, of the steps 151-155 based on their configuration, which includes dependencies (predecessor, successor, etc.) on the other steps. Once the job step DAG 156 is created, the step linker 145 understands the data flow so it can configure the inputs and/or outputs of the different steps accordingly. Once created, the job step DAG 156 is returned to the pipeline manager 142 in response to a request from the pipeline manager 142.

The pipeline manager 142 then creates a pipeline job 158 and associates the data included in the start job request with it, along with the job step DAG 156. The pipeline job 158 is then passed to a job submitter module 146, which utilizes an appropriate pipeline API for execution on the target pipeline 120. In some examples, the target pipeline is a commercially available stream/batch data processing engine, a customized stream/batch data processing engine or a large-scale analytics engine. In some examples and features of the instant solution, the parallelism configuration data initially included in the start job request and associated with the pipeline job 158 may be utilized by the job submitter 146 module when initiating execution on the target pipeline 120. In some examples, the parallelism configuration data is a simple boolean value to indicate whether or not parallel step execution is supported. In other examples, the parallelism configuration data identifies a number of threads to be utilized for execution and/or a desired pre-defined thread pool.

In some examples and features of the instant solution, a user interface (UI) 160 that executes on a user device 170, is communicatively coupled to a processor in the host platform 112. The UI 160 running on the user device 170 enables communication with the pipeline management host platform 112, the management components 142-146 running on it, and the configuration files 114-118, as well as other components or modules in the system 100. In some examples, the pipeline manager 142 initiates the interaction with the user interface 160. In other examples, the user interface 160 may initiate a request to start a job and the user interface may request and receive job status updates. In some examples, the user interface can request visualization data that reflects the job step DAG 156.

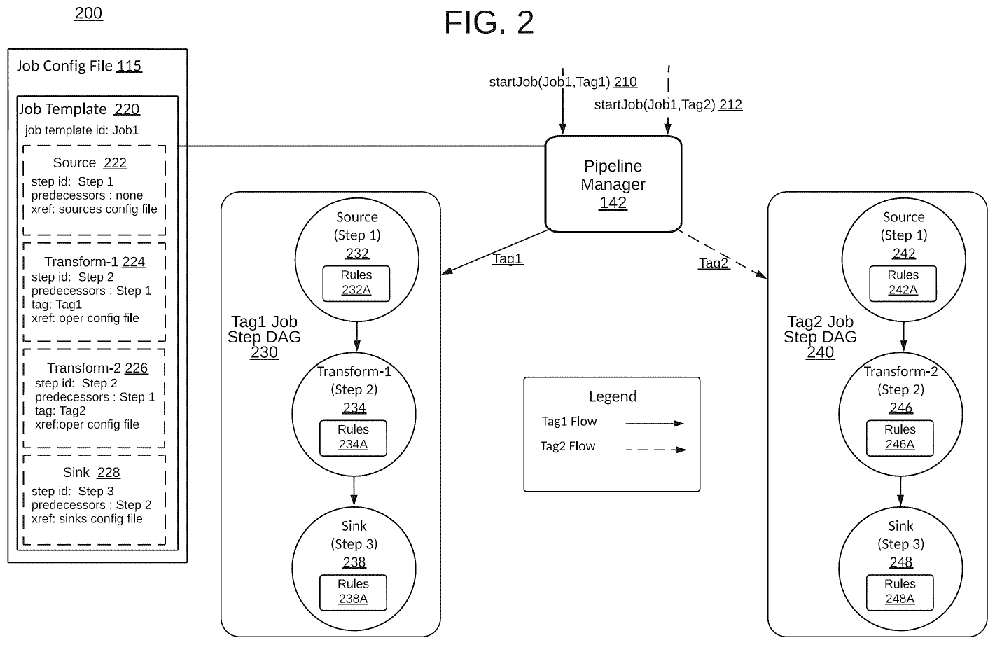

FIG. 2 illustrates a process 200 for pipeline job construction that supports tag-based execution paths, according to examples and features of the instant solution. Referring now to FIG. 2, the pipeline manager 142 receives a start job request 210 with a job template identifier of Job1 and a tag of Tag1. The pipeline manager 142 or the step creator 143 (see FIG. 1) locates the job template 220 in a job config file 115 using the supplied job template identifier. The job template 220 includes a list of job step configurations 222-228, which include a step identifier, a list of predecessor steps, and optionally a list of job tags. In some examples, the step configurations 222-228 may contain cross references (shown as ‘xref’ in FIG. 2) to other configuration files.

In some examples and features of the instant solution, once the job template has been retrieved, the pipeline manager 142 or the step creator 143 parses the list of job step definitions 222-228 and filters the step configurations applicable to the supplied tag (Tag1 in this example). In some examples, a step configuration that contains no tags is considered a common step in the job template and is applicable to all jobs created using the template. In some examples, a special common step tag is expected to indicate that a step is applicable to all jobs created using the template. In this example, since Tag1 was supplied, step configurations 222, 224 and 228 are utilized in the step creation process because they either contain no tags or are tagged explicitly for Tag1. The pipeline manager 142 or the step creator 143 creates the steps 232, 234, and 238 which correspond to the step configurations 222, 224, and 228. Step configuration data 222, 224, 228 utilized later in the job creation process (e.g. predecessors) is stored in each step 232, 234, and 238. As described in FIG. 1, each step configuration is also associated with a set of operation rules. When a step 232, 234, and 238 is created, these rules are parsed, resolved of placeholders, and optionally compiled. The resultant set of executables rules 232A, 234A, 238A are associated with the corresponding steps 232, 234, 238 for execution in the pipeline 120 (see FIG. 1).

In this example, once the steps 232, 234, and 238 are created, the pipeline manager 142 or the step linker 145 (see FIG. 1) generates a job step DAG 230, by utilizing the predecessor configuration stored in steps 232, 234 and 238. This job step DAG 230 is included in a pipeline job 158 (see FIG. 1) and executed in pipeline 120. When executed, the pipeline job 158 (see FIG. 1) utilizing job step DAG 230, will read data from a source (step 1) 232, perform transform-1 (step 2) 234 on the data from the source, and store the transformed data in a sink (step 3) 238.

Referring again to FIG. 2, in this example, the pipeline manager 142 receives a start job request 212, with a job template identifier of Job1 and a different tag, Tag2. As previously described, the pipeline manager 142 and its pipeline management components, the step creator 143 and the step linker 145, generate a job step DAG 240 that reflects the Tag2 filter. In this example, a step configuration transform-2 226 is used as its tag configuration includes Tag2 instead of transform-1 224, which was used in the previous example. As previously described, and as depicted in FIG. 1, this job step DAG 240 is included in a pipeline job 158 which is executed in pipeline 120. When executed, the pipeline job 158 utilizing the job step DAG 240 will read data from a source (step 1) 242, transform-2 (step 2) 246 will be performed on the data from the source, and the transformed data will be stored in a sink (step 3) 248.

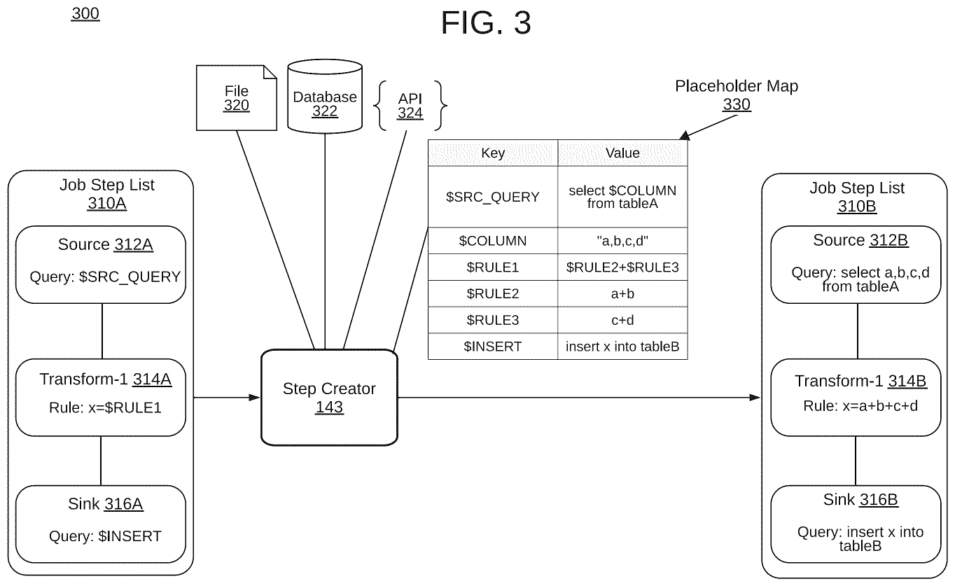

FIG. 3 illustrates a process 300 for placeholder resolution and replacement according to examples and features of the instant solution. Referring now to FIG. 3, in some examples, the step creator 143 initially builds a job step list 310A after parsing an identified job template 220 (see FIG. 2) in a job config file 115 (see FIGS. 1-2). In some examples, the steps 312A-316A are initially constructed with the step configuration found in the rules config file 114, the job config file 115 and other related data config files 116-118 (see FIG. 1). Step configuration, including step type specific configuration, like the query attribute in Source 312A and sink 316A, may include one or more string placeholders (e.g. $SRC_QUERY) as markers to be replaced before job execution in the pipeline 120 (see FIG. 1). Further, in some examples and features of the instant solution, step rules configured in the rules config file 114 may include one or more placeholders. Late resolution of these placeholders with actual values provides flexibility to job developers and to systems as it enables them to have common template code which can then be updated with specific values for the job in question.

Referring again to FIG. 3, in some examples and features of the instant solution, once the initial job step list 310A is constructed, the step creator 143 constructs a key value placeholder map 330 of all placeholders found in the job steps 312A-316A. The placeholder name acts as the key to the placeholder map 330. The placeholder values are retrieved from one or more of a file 320, a database 322 or an API call 324. In some examples, the values are retrieved from one or more of the configuration files 114-118 (see FIG. 1) that contain various aspects of the job configuration.

In some examples, once the placeholder map 330 is constructed, the step creator 143, accesses the placeholder map 330 to resolve each placeholder in the configuration and rules of steps 312A-316A. When the placeholder map is accessed, the value returned may not be completely resolved as it too may contain one or more placeholders. Examples of this include $SRC_QUERY and $RULE1 in the placeholder map 330. In this scenario, the map is recursively accessed until the returned value is free of placeholders—e.g. the placeholder value is fully resolved and ready for use during job execution. In this example, the resulting updated steps 312B-316B in job step list 310B are the same steps as those depicted in job step list 310A after placeholder resolution is completed. For example, sink 316A includes a query attribute that is defined as a placeholder $INSERT. A non-recursive lookup in the placeholder map 330 resolves that to ‘insert x into tableB’. The $SRC_QUERY resolution in 312A requires recursion as the initial resolution yields ‘select $COLUMN from tableA’, so $COLUMN is expected to also be resolved. That lookup returns ‘a,b,c,d’, yielding the ultimate resolution of ‘select a,b,c,d from tableA’ as seen in source 312B step.

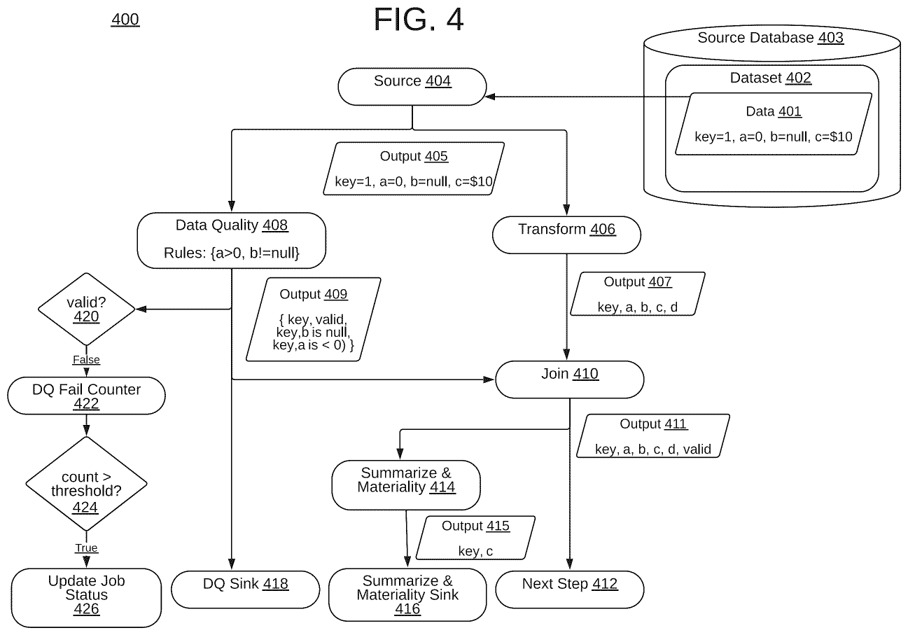

FIG. 4 illustrates a process 400 for inline data quality verification according to examples and features of the instant solution. Traditionally data quality verification is performed pre-pipeline or post-pipeline job execution. Inline data quality verification enables detection of data quality issues during execution of the job so that the job execution status can be marked as failed prior to job execution across the entire dataset. Further, all job execution details are recorded which enables summarization of the pipeline job execution across the entire dataset along with recording of the data that failed data quality checks.

In one example of the instant solution, a data quality verification step configuration, which includes a reference to another step to which it is a predecessor, is included in a job template, such as job template 220 (see FIG. 2). During the step creation process described previously in FIGS. 1 and 2, a data quality step is created and includes a set of data quality rules that cover one or more of the attributes in the data that is input to the step. The output of a data quality step includes at least one of the key of the data provided as input to the step, an overall data validity boolean value, and a list of attribute level data quality validation results. In some examples of the instant solution, the presence of a peer step to the data quality step (e.g. a transformation step), results in the automatic creation of a join step to merge the output of the data quality step with the output of the peer step. In other examples of the instant solution an inline data quality step type exists that results in the join step being automatically created and a normal data quality step type that does not.

Referring now to FIG. 4, in one example, a job flow, consisting of steps and actions 404-420 are executing in the pipeline 120 (see FIG. 1). The job flow begins with a source 404 reading data 401 from a dataset 402, stored in a source database 403. Included in the data 401 is a key (1 in this example), and three other attributes a, b, and c with values 0, null and $10 respectively. In this example, the c value is the monetary impact of this data 401 being invalid. Upon reading the data 401, the source 404 emits an output 405 which includes the key and attributes of data 401. This output is sent to two peer successor steps, transform 406 and data quality 408. The transform step 406 performs a data transformation which generates a new attribute d. The new attribute d, along with the key and attributes of the input data to the step (output 405), are included in an output 407 which serves as one of the inputs to the join step 410 which will be executed when the output of the data quality step 408 is available.

The data quality step 408 executes its rules on the a and b attributes of output 405 which serves as the input data to this step. In this example, both attribute checks fail, as a=0 and b=null. Given this, the output 409 of the data quality 408 verification step includes an entry indicating the data 401, identified by key 1, is invalid, along with separate entries for each of the attributes that failed validation including a reason of the validation failure. The output 409 is used as the input to three subsequent peer steps including the join step 410, the data quality (DQ) sink step 418, and the DQ fail counter step 422. In some examples and features of the instant solution, the data quality 408 verification step 408 executes concurrently to the transform step 406. In other examples and features of the instant solution, concurrent execution of these steps is dependent on the parallelism configuration parameters supplied in the start job request to the pipeline manager 142 (see FIGS. 1-2).

The join step 410 executes upon receiving output 409 from the data quality step 408 and combines the overall data validation result, with the data included in the output 407 using the data key (1 in this example), to produce output 411. Output 411 is used as an input to peer subsequent steps 412-414. Next step 412 represents a next step in this pipeline job which may be a sink step, a transform step, or the like depending on the operational goal of the job.

The summarize and materiality step 414 executes upon receiving the output 411. In this example, the summarize and materiality step 414 collects and outputs the monetary cost of invalid data, which is held in attribute c (for example, $10 for data 401). If output 411 reflects invalid data, the c attribute value, along with the key, is included in the output 415 which is recorded in a data store by the summarize and materiality sink step 416. In other examples of the instant solution the summarize and materiality step 414 may perform one or more operations such as, but not limited to, including all of the data attributes from output 411 into output 415 for recording, counting the number of data 401 (which may be valid) in the dataset 402, and counting the number of data 401 (which may be invalid) in the dataset 402.

In some examples and features of the instant solution, output 409 is processed by a Data Quality (DQ) sink 418, which is responsible for recording, against the key of the invalid data 401, all failed attribute level validation results included in output 409. This level of detailed validation error recording enables more efficient location and correction of data quality issues.

In some examples and features of the instant solution, output 409 is processed by a validity check step 420. If the boolean validation entry is false, then a DQ fail counter step 422 is executed which increments a count of the number of data quality failures encountered by the pipeline job execution to this point. The validity check step 420 and the DQ fail counter step 422 may be different steps or may be the same step.

In some examples and features of the instant solution, a threshold check step 424 is executed to determine if the count incremented by the DQ fail counter step 422 is over a configured threshold. If the count is over the threshold, then an update job status 426 step is executed which sets the job execution status to failed and halts execution of the pipeline job 158 (see FIG. 1) in the pipeline 120 (see FIG. 1). In some examples of the instant solution, the threshold check step 424 and the update job status 426 step are the same step.

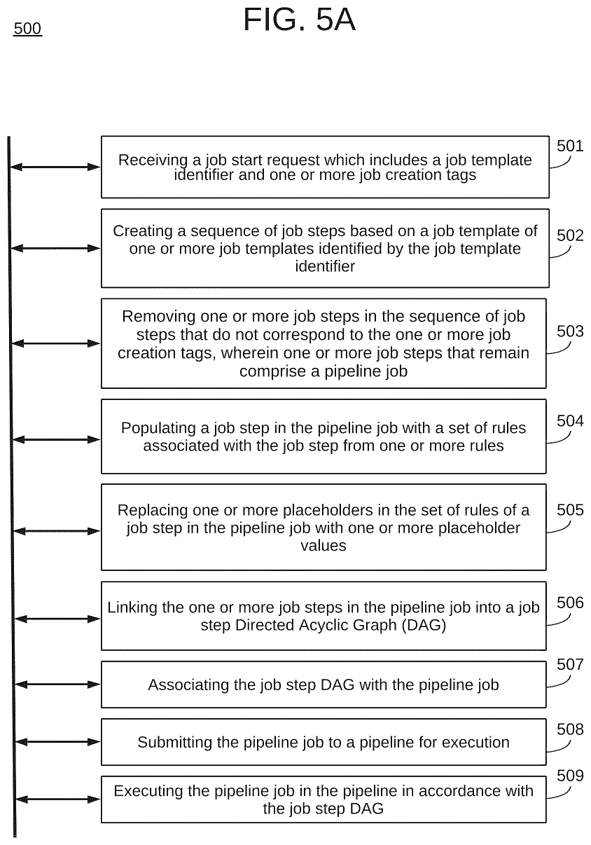

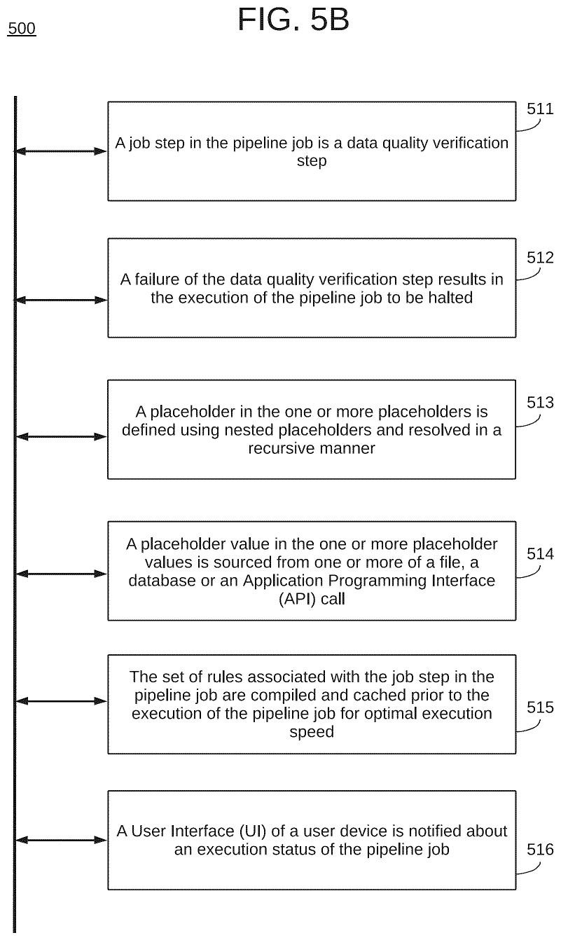

FIGS. 5A-5B illustrate a process for pipeline job creation and execution, according to examples and features of the instant solution. For example, the process 500 may be performed by at least one processor of a host platform such as a server, virtual machine, container, or the like which is communicatively coupled to a data store which is storing one or more job templates and one or more rules. Referring to FIG. 5A, in 501, the process may include receiving a job start request which includes a job template identifier and one or more job creation tags, in 502 creating a sequence of job steps based on a job template of the one or more job templates identified by the job template identifier, and in 503 removing one or more job steps in the sequence of job steps that do not correspond to the one or more job creation tags, wherein one or more job steps that remain comprise a pipeline job. In 504, the process may include populating a job step in the pipeline job with a set of rules associated with the job step from the one or more rules, in 505 replacing one or more placeholders in the set of rules of the job step in the pipeline job with one or more placeholder values and in 506 linking the one or more job steps in the pipeline job into a job step Directed Acyclic Graph (DAG). In 507, the process may include associating the job step DAG with the pipeline job, in 508, submitting the pipeline job to a pipeline for execution and in 509 executing the pipeline job in the pipeline in accordance with the job step DAG.

Referring now to FIG. 5B, the process 500 may additionally include an option 511 that a job step in the pipeline job is a data quality verification step, in 512 a failure of the data quality verification step results in the execution of the pipeline job to be halted, and in 513 a placeholder in the one or more placeholders is defined using nested placeholders and resolved in a recursive manner. In 514, the process may include an option that a placeholder value in the one or more placeholder values is sourced from one or more of a file, a database or an Application Programming Interface (API) call, in 515 the set of rules associated with the job step in the pipeline job are compiled and cached prior to the execution of the pipeline job for optimal execution speed and in 516 a User Interface (UI) of a user device is notified about an execution status of the pipeline job.

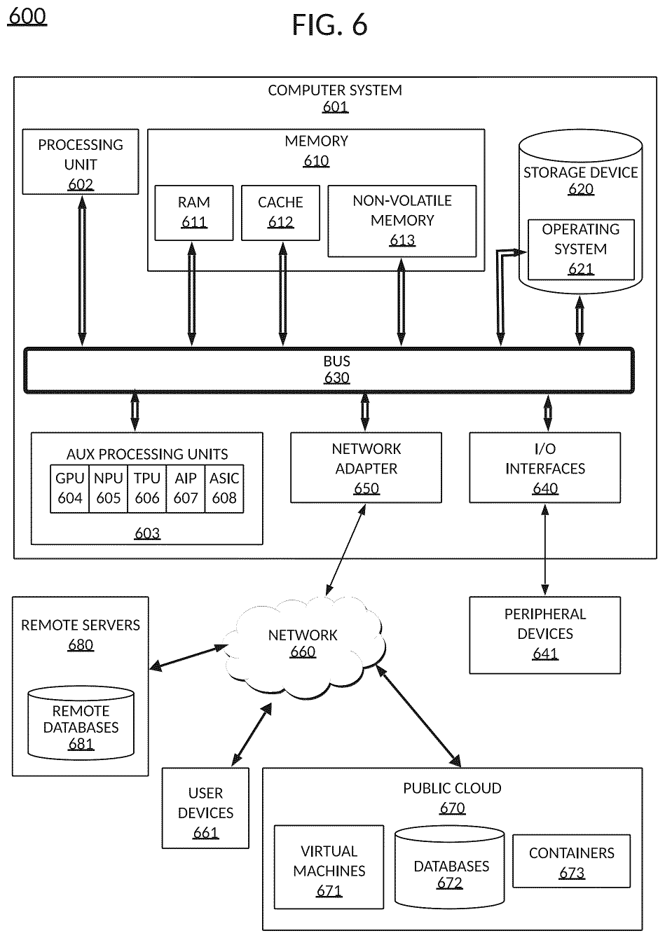

The above examples of the instant solution may be implemented in hardware, in a computer program executed by a processor, in firmware, or in a combination of the above. A computer program may be embodied on a computer-readable storage medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 6 illustrates an example computer system architecture, which may represent or be integrated in any of the above-described components, etc.

FIG. 6 illustrates a computing environment according to the instant solution's example features, structures, or characteristics. FIG. 6 is not intended to suggest any limitation as to the scope of use or functionality of features, structures, or characteristics of the instant solution of the application described herein. Regardless, the computing environment 600 can be implemented to perform any of the functionalities described herein. In computing environment 600, there is a computer system 601, operational within numerous other general-purpose or special-purpose computing system environments or configurations.

Computer system 601 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 660 or querying a database. Depending upon the technology, the performance of a computer-implemented method may be distributed among multiple computers and among multiple locations. However, in this presentation of the computing environment 600, a detailed discussion is focused on a single computer, specifically computer system 601, to keep the presentation as simple as possible.

Computer system 601 may be located in a cloud, even though it is not shown in a cloud in FIG. 6. On the other hand, computer system 601 may not be in a cloud except to any extent as may be affirmatively indicated. Computer system 601 may be described in the general context of computer system-executable instructions, such as program modules, executed by a computer system 601. Generally, program modules may include routines, programs, objects, components, logic, data structures, and so on that perform tasks or implement certain abstract data types. As shown in FIG. 6, computer system 601 in computing environment 600 is shown in the form of a general-purpose computing device. The components of computer system 601 may include but are not limited to, at least one processor or processing unit 602, a system memory 610, and a bus 630 that couples various system components, including system memory 610 to processing unit 602.

Processing unit 602 includes at least one computer processor of any type now known or to be developed. The processing unit 602 may contain circuitry distributed over multiple integrated circuit chips. The processing unit 602 may also implement multiple processor threads and multiple processor cores. Cache 612 is a memory that may be in the processor chip package(s) or located “off-chip,” as depicted in FIG. 6. Cache 612 is typically used for data or code accessed by the threads or cores running on the processing unit 602. In some computing environments, processing unit 602 may be designed to work with qubits and perform quantum computing.

The Auxiliary Processing Units (APU) 603 may contain at least one Graphics Processing Unit (GPU) 604, Neural Processing Unit (NPU) 605, Tensor Processing Unit (TPU) 606, AI Processor (AIP) 607, or other Application Specific Integrated Circuit (ASIC) 608. The at least one APU 603 may contain circuitry distributed over multiple integrated circuit chips. Each APU 603 may implement multiple processor threads and multiple processor cores. Each APU 603 may include at least one of onboard memory, onboard memory cache, and onboard instruction cache. Each APU may be communicatively coupled to the system bus 630 and configure to communicate with other system components, including a processing unit 602, system cache 612, RAM 611, non-volatile RAM 613, operating system 621, Network adapter 650, and Input/Output interfaces 640. In some computing environments, at least one of the at least one APU 603 may be designed to work with qubits and perform quantum computing.

Memory 610 is any volatile memory now known or to be developed in the future. Examples include dynamic random-access memory (RAM) 611 or static type RAM 611. Typically, the volatile memory is characterized by random access, but this may not be the characterization unless affirmatively indicated. In computer system 601, memory 610 is in a single package. It is internal to computer system 601, but alternatively or additionally, the volatile memory may be distributed over multiple packages and/or located externally with respect to computer system 601. By way of example, memory 610 can be provided for reading from and writing to a non-removable, non-volatile magnetic media (shown as storage device 620, and typically called a “hard drive”). Memory 610 may include at least one program product having a set (e.g., at least one) of program modules configured to carry out the functions of various features, structures, or characteristics of the instant solution of the application. A typical computer system 601 may include cache 612, a specialized volatile memory generally faster than RAM 611 and generally located closer to the processing unit 602. Cache 612 stores frequently accessed data and instructions accessed by the processing unit 602 to speed up processing time. The computer system 601 may also include non-volatile memory 613 in the form of ROM, PROM, EEPROM, and flash memory. Non-volatile memory 613 often contains programming instructions for starting the computer, including the basic input/output system (BIOS) and information to start the operating system 621.

Computer system 601 may include a removable/non-removable, volatile/non-volatile computer storage device 620. For example, storage device 620 can be a non-removable, non-volatile magnetic media (not shown and typically called a “hard drive”). At least one data interface can connect it to the bus 630. In features, structures, or characteristics of the instant solution where computer system 601 has a large amount of storage (for example, where computer system 601 locally stores and manages a large database), then this storage may be provided by peripheral storage devices 620 designed for storing very large amounts of data, such as a storage area network (SAN) that is shared by multiple, geographically distributed computers.

The operating system 621 is software that manages computer system 601 hardware resources and provides common services for computer programs. Operating system 621 may take several forms, such as various known proprietary operating systems or open-source Portable Operating System Interface type operating systems that employ a kernel.

The bus 630 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 630 is the signal conduction path that allows the various components of computer system 601 to communicate.

Computer system 601 may communicate with at least one peripheral device, 641, via an input/output (I/O) interface, 640. Such devices may include a keyboard, a pointing device, a display, etc.; at least one device that enables a user to interact with computer system 601; and/or any devices (e.g., network card, modem, etc.) that enable computer system 601 to communicate with at least one other computing devices. Such communication can occur via I/O interface 640. As depicted, I/O interface 640 communicates with the other components of computer system 601 via bus 630.

Network adapter 650 enables the computer system 601 to connect and communicate with at least one network 660, such as a local area network (LAN), a wide area network (WAN), and/or a public network (e.g., the Internet). It bridges the computer's internal bus 630 and the external network, exchanging data efficiently and reliably. The network adapter 650 may include hardware, such as modems or Wi-Fi signal transceivers, and software for packetizing and/or de-packetizing data for communication network transmission. Network adapter 650 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 660 is any computer network that can receive and/or transmit data. Network 660 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 660 may be replaced and/or supplemented by LANs designed to communicate data between devices in a local area, such as a Wi-Fi network. The network 660 typically includes computer hardware such as copper transmission cables, optical transmission fibers, wireless transmission, routers, firewalls, switches, gateway computers, edge servers, and network infrastructure known now or to be developed in the future. Computer system 601 connects to network 660 via network adapter 650 and bus 630.

User devices 661 are any computer systems used and controlled by an end user in connection with computer system 601. For example, in a hypothetical case where computer system 601 is designed to provide a recommendation to an end user, this recommendation may typically be communicated from network adapter 650 of computer system 601 through network 660 to a user device 661, allowing user device 661 to display, or otherwise present, the recommendation to an end user. User devices can be a wide array, including personal computers, laptops, tablets, hand-held, mobile phones, etc.

A public cloud 670 is an on-demand availability of computer system resources, including data storage and computing power, without direct active management by the user. Public clouds 670 are often distributed, with data centers in multiple locations for availability and performance. Computing resources on public clouds 670 are shared across multiple tenants through virtual computing environments comprising virtual machines 671, databases 672, containers 673, and other resources. A container 673 is an isolated, lightweight software for running a software application on the host operating system 621. Containers 673 are built on top of the host operating system's kernel and contain software applications and some lightweight operating system APIs and services. In contrast, virtual machine 671 is a software layer with an operating system 621 and kernel. Virtual machines 671 are built on top of a hypervisor emulation layer designed to abstract a host computer's hardware from the operating software environment. Public clouds 670 generally offers databases 672, abstracting high-level database management activities. At least one element described or depicted in FIG. 6 can perform at least one of the actions, functionalities, or features described or depicted herein.

Remote servers 680 are any computers that serve at least some data and/or functionality over a network 660, for example, WAN, a virtual private network (VPN), a private cloud, or via the Internet to computer system 601. These networks 660 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 680 can also host remote databases 681, with the database located on one remote server 680 or distributed across multiple remote servers 680. Remote databases 681 are accessible from database client applications installed locally on the remote server 680, other remote servers 680, user devices 661, or computer system 601 across a network 660. An AI/ML model described or depicted here may reside fully or partially on any of the elements described or depicted in FIG. 6.

Although an exemplary example of the instant solution of at least one of a system, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. A system, comprising:
a data store configured to store one or more job templates and one or more rules; and
a processor communicatively coupled to the data store, wherein the processor is configured to:
receive a job start request which includes a job template identifier and one or more job creation tags,
create a sequence of job steps based on a job template of the one or more job templates identified by the job template identifier,
remove one or more job steps in the sequence of job steps that do not correspond to the one or more job creation tags, wherein one or more job steps that remain comprise a pipeline job,
populate a job step of the one or more job steps that remain in the pipeline job with a set of rules associated with the job step from the one or more rules,
replace one or more placeholders in the set of rules of the job step in the pipeline job with one or more placeholder values,
link the one or more job steps in the pipeline job into a job step Directed Acyclic Graph (DAG),
associate the job step DAG with the pipeline job,
submit the pipeline job to a pipeline for execution; and
execute the pipeline job in the pipeline in accordance with the job step DAG.

2. The system of claim 1, wherein the job step in the pipeline job is a data quality verification step.

3. The system of claim 2, wherein a failure of the data quality verification step results in the pipeline job being executed to be halted.

4. The system of claim 1, wherein a placeholder in the one or more placeholders is defined using nested placeholders and resolved in a recursive manner.

5. The system of claim 1, wherein a placeholder value in the one or more placeholder values is sourced from one or more of a file, a database or an Application Programming Interface (API) call.

6. The system of claim 1, wherein the set of rules associated with the job step in the pipeline job are compiled and cached prior to the pipeline job being executed for optimal execution speed.

7. The system of claim 1, wherein a User Interface (UI) of a user device is notified about an execution status of the pipeline job, wherein the user device and the processor are communicatively coupled.

8. A method, comprising:
receiving a job start request which includes a job template identifier and one or more job creation tags,
creating a sequence of job steps based on a job template identified by the job template identifier,
removing one or more job steps in the sequence of job steps that do not correspond to the one or more job creation tags, wherein one or more job steps that remain comprise a pipeline job,
populating a job step in the pipeline job with a set of rules associated with the job step from one or more rules,
replacing one or more placeholders in the set of rules of the job step in the pipeline job with one or more placeholder values,
linking the one or more job steps in the pipeline job into a job step Directed Acyclic Graph (DAG),
associating the job step DAG with the pipeline job,
submitting the pipeline job to a pipeline for execution; and
executing the pipeline job in the pipeline in accordance with the job step DAG.

9. The method of claim 8, wherein a job step in the pipeline job is a data quality verification step.

10. The method of claim 9, wherein a failure of the data quality verification step results in the pipeline job being executed to be halted.

11. The method of claim 8, wherein a placeholder in the one or more placeholders is defined using nested placeholders and resolved in a recursive manner.

12. The method of claim 8, wherein a placeholder value in the one or more placeholder values is sourced from one or more of a file, a database or an Application Programming Interface (API) call.

13. The method of claim 8, wherein the set of rules associated with the job step in the pipeline job are compiled and cached prior to the pipeline job being executed for optimal execution speed.

14. The method of claim 8, wherein a User Interface (UI) of a user device is notified about an execution status of the pipeline job.

15. A computer-readable storage medium comprising instructions that when read by a processor cause the processor to perform:
receiving a job start request which includes a job template identifier and one or more job creation tags,
creating a sequence of job steps based on a job template identified by the job template identifier,
removing one or more job steps in the sequence of job steps that do not correspond to the one or more job creation tags, wherein one or more job steps that remain comprise a pipeline job,
populating a job step in the pipeline job with a set of rules associated with the job step from one or more rules,
replacing one or more placeholders in the set of rules of the job step in the pipeline job with one or more placeholder values,
linking the one or more job steps in the pipeline job into a job step Directed Acyclic Graph (DAG),
associating the job step DAG with the pipeline job,
submitting the pipeline job to a pipeline for execution; and
executing the pipeline job in the pipeline in accordance with the job step DAG.

16. The computer-readable storage medium of claim 15, wherein a job step in the pipeline job is a data quality verification step.

17. The computer-readable storage medium of claim 16, wherein a failure of the data quality verification step results in the pipeline job being executed to be halted.

18. The computer-readable storage medium of claim 15, wherein a placeholder in the one or more placeholders is defined using nested placeholders and resolved in a recursive manner.

19. The computer-readable storage medium of claim 15, wherein a placeholder value in the one or more placeholder values is sourced from one or more of a file, a database or an Application Programming Interface (API) call.

20. The computer-readable storage medium of claim 15, wherein the set of rules associated with the job step in the pipeline job are compiled and cached prior to the pipeline job being executed for optimal execution speed.
